(19) United States
(12) Patent Application Publication
(10) Pub. No.: US 2021/0288325 A1
(43) Pub. Date: Sep. 16, 2021

(54) NON-AQUEOUS ELECTROLYTE SECONDARY BATTERY NEGATIVE ELECTRODE, NON-AQUEOUS ELECTROLYTE SECONDARY BATTERY INCLUDING SAME AND METHOD FOR MANUFACTURING SAME

(71) Applicant: HONDA MOTOR CO., LTD., Tokyo (JP)

(72) Inventors: Makiko Takahashi, Saitama (JP); Kiyoshi Tanaami, Saitama (JP); Tomohiro Kinoshita, Saitama (JP); Shintaro Aoyagi, Saitama (JP); Takashi Mukai, Osaka (JP); Yuta Ikeuchi, Osaka (JP); Taichi Sakamoto, Osaka (JP); Naoto Yamashita, Osaka (JP)

(21) Appl. No.: 17/197,062

(22) Filed: Mar. 10, 2021

(30) Foreign Application Priority Data
Mar. 13, 2020 (JP) 2020-044790

(51) Int. Cl. H01M 4/62; H01M 4/134; H01M 4/1395; H01M 4/04; H01M 4/38

(52) U.S. Cl. CPC H01M 4/62; H01M 4/134; H01M 2004/027; H01M 4/0404; H01M 4/386; H01M 4/1395

(57) ABSTRACT

An object is to provide a non-aqueous electrolyte secondary battery negative electrode which can improve a battery life as compared with a conventional one, a non-aqueous electrolyte secondary battery including it and a method for manufacturing it. A non-aqueous electrolyte secondary battery negative electrode includes: a collector; and a negative electrode layer formed on the collector, the negative electrode layer includes a negative electrode active material, a conductivity aid, a binder and a skeleton-forming agent including a silicate having a siloxane bond or a phosphate having a phosphate bond and the skeleton-forming agent is arranged on at least the interface of the negative electrode layer with the collector.

This application is based on and claims the benefit of priority from Japanese Patent Application 2020-044790, filed on 13 Mar. 2020, the content of which is incorporated herein by reference.

### BACKGROUND OF THE INVENTION

### Field of the Invention

The present invention relates to a non-aqueous electrolyte secondary battery negative electrode, a non-aqueous electrolyte secondary battery including the same and a method for manufacturing the same.

### Related Art

In recent years, since non-aqueous electrolyte secondary batteries such as a lithium-ion secondary battery have been small and lightweight and have produced a high output, they have been increasingly used for automobiles and the like. The non-aqueous electrolyte secondary battery is a generic name for a battery system that uses, as its electrolyte, an electrolyte whose main component is not water and an electricity storage device that can be charged and discharged. For example, a lithium-ion battery, a lithium-polymer battery, a lithium all-solid-state battery, a lithium-air battery, a lithium-sulfur battery, a sodium-ion battery, a potassium-ion battery, a polyvalent ion battery, a sodium-sulfur battery and the like are known. The non-aqueous electrolyte secondary battery is mainly formed with a positive electrode, a negative electrode and an electrolyte. When the electrolyte has fluidity, a separator is further interposed between the positive electrode and the negative electrode.

Incidentally, in the non-aqueous electrolyte secondary battery described above, its battery life is required to be improved. Hence, a technology is disclosed in which a skeleton-forming agent including a silicate having a siloxane bond is made to exist on at least the surface of an active material layer and in which the skeleton-forming agent is made to penetrate from the surface thereinto (see, for example, Patent Document 1). It is disclosed that, with this technology, a strong skeleton can be formed in the active material layer so as to improve the battery life. A technology is also disclosed in which the skeleton-forming agent described above is applied to a negative electrode including a silicon (Si)-based active material (see, for example, Patent Document 2), and a manufacturing method is also disclosed in which the skeleton-forming agent described above is made to penetrate after the application of a negative electrode material (see, for example, Patent Document 3).

Patent Document 1: Japanese Patent No. 6369818

Patent Document 2: Japanese Patent No. 6149147

Patent Document 3: Japanese Unexamined Patent Application, Publication No. 2018-101638

### SUMMARY OF THE INVENTION

However, even in the technologies of Patent Documents 1 to 3, in particular, when they are applied to a negative electrode layer including a Si-based active material, the Si-based active material is significantly expanded and contracted at the time of charging and discharging, and thus peeling or cracking may occur in the negative electrode layer. Hence, it is likely that, with the technologies of Patent Documents 1 to 3, a sufficient battery life cannot be obtained, and thus it is desirable to further improve a battery life.

The present invention is made in view of the situation described above, and an object thereof is to provide a non-aqueous electrolyte secondary battery negative electrode which can improve a battery life as compared with a conventional one, a non-aqueous electrolyte secondary battery including it and a method for manufacturing it.

(1) In order to achieve the object described above, the present invention provides a non-aqueous electrolyte secondary battery negative electrode including: a collector; and a negative electrode layer formed on the collector, in which the negative electrode layer includes a negative electrode active material, a conductivity aid, a binder and a skeleton-forming agent including a silicate having a siloxane bond or a phosphate having a phosphate bond and in which the skeleton-forming agent is arranged on at least the interface of the negative electrode layer with the collector.

(2) In the non-aqueous electrolyte secondary battery negative electrode of (1), a content of the skeleton-forming agent in the negative electrode layer may be 3.0 to 40.0% by mass.

(3) In the non-aqueous electrolyte secondary battery negative electrode of (1) or (2), the bulk density of the conductivity aid may be 0.04 to 0.25 mg/cm³.

(4) In the non-aqueous electrolyte secondary battery negative electrode of any one of (1) to (3), a content of the conductivity aid in the negative electrode layer may be 8.8 to 25.0% by mass.

(5) In the non-aqueous electrolyte secondary battery negative electrode of any one of (1) to (4), the negative electrode active material may include a silicon-based material containing silicon.

(6) The present invention also provides a non-aqueous electrolyte secondary battery including the non-aqueous electrolyte secondary battery negative electrode of any one of (1) to (5).

(7) The present invention also provides a method for manufacturing a non-aqueous electrolyte secondary battery negative electrode including a collector and a negative electrode layer formed on the collector, the method including: a first step of applying, on the collector, a negative electrode material including a negative electrode active material, a conductivity aid and a binder and drying the negative electrode material so as to form a negative electrode layer precursor; and a second step of impregnating the negative electrode layer precursor formed in the first step with a skeleton-forming agent including a silicate having a siloxane bond or a phosphate having a phosphate bond and drying the negative electrode layer precursor so as to form the negative electrode layer, in which B/A which is a ratio of the density B of the negative electrode layer formed in the second step to the density A of the negative electrode layer precursor formed in the first step is in a range of 0.9<B/A<1.4.

(8) In the method for manufacturing a non-aqueous electrolyte secondary battery negative electrode of (7), the density A of the negative electrode layer precursor formed in the first step may be 0.5 to 1.3 g/cm³.

According to the present invention, it is possible to provide a non-aqueous electrolyte secondary battery negative electrode which can improve a battery life as compared with a conventional one, a non-aqueous electrolyte secondary battery including it and a method for manufacturing it.

### BRIEF DESCRIPTION OF THE DRAWINGS

FIG. 1 is a cross-sectional schematic view of a non-aqueous electrolyte secondary battery negative electrode according to an embodiment of the present invention;

FIG. 2 is a cross-sectional schematic view of a conventional non-aqueous electrolyte secondary battery negative electrode;

FIG. 3 is an EDX mapping diagram of a cross section of a lithium-ion secondary battery negative electrode in Example 6;

FIG. 4 is an EDX mapping diagram of a cross section of a lithium-ion secondary battery negative electrode in Comparative Example 2;

FIG. 5 is a charge/discharge curve diagram in Example 6 and Comparative Example 2;

FIG. 6 is a diagram showing a relationship between the amount of conductivity aid and a density A;

FIG. 7 is a diagram showing a relationship between the amount of conductivity aid and the amount of skeleton-forming agent;

FIG. 8 is a diagram showing a relationship between the amount of conductivity aid and density B/density A;

FIG. 9 is a diagram showing a relationship between the amount of conductivity aid and the density A in various types of conductivity aids;

FIG. 10 is a diagram showing a relationship between the density A and a charge/discharge capacity;

FIG. 11 is a diagram showing a relationship between the amount of skeleton-forming agent and the charge/discharge capacity; and

FIG. 12 is a diagram showing a relationship between the density B/density A and the charge/discharge capacity.

### DETAILED DESCRIPTION OF THE INVENTION

An embodiment of the present invention will be described in detail below.

### [Negative Electrode]

The non-aqueous electrolyte secondary battery negative electrode according to the present embodiment includes a collector and a negative electrode layer formed on the collector. More specifically, the negative electrode layer includes a negative electrode active material, a conductivity aid, a binder and a skeleton-forming agent including a silicate having a siloxane bond or a phosphate having a phosphate bond, and the skeleton-forming agent is arranged on at least an interface of the negative electrode layer with the collector. For example, the present embodiment is applied to a lithium-ion secondary battery negative electrode so as to be able to provide a lithium-ion secondary battery negative electrode which has a high strength and excellent heat resistance and whose cycle life characteristics are improved, a lithium-ion secondary battery including it and a method for manufacturing it. Although an example where the present embodiment is applied to the lithium-ion secondary battery negative electrode will be described in detail below, various additions, modifications or deletions can be made without departing from the spirit of the present invention.

Although the negative electrode active material of the present embodiment is not particularly limited as long as the negative electrode active material can reversibly store and release lithium ions, a silicon-based material containing silicon is preferably used. Elemental silicon, a silicon alloy, a silicon oxide, a silicon compound and the like apply as the silicon-based material. Here, the elemental silicon refers to crystalline or amorphous silicon whose purity is equal to or greater than 95% by mass. The silicon alloy means a Si-M alloy formed of silicon and another transition element M, examples of M include Al, Mg, La, Ag, Sn, Ti, Y, Cr, Ni, Zr, V, Nb, Mo and the like and the silicon alloy may be an all-proportional solid solution alloy, a eutectic alloy, a hypoeutectic alloy, a hypereutectic alloy or a peritectic alloy. The silicon oxide means an oxide of silicon or a complex formed of elemental silicon and SiO₂, and in the elemental ratio of Si and O, O is preferably equal to or less than 1.7 with the assumption that Si is 1. The silicon compound refers to a substance in which silicon and two or more types of other elements are chemically bonded together. Among them, the elemental silicon is preferable because an interface layer which will be described later can be satisfactorily formed. Alternatively, a material obtained by mixing or compounding a carbon-based material with the silicon-based material can be used.

The shape of the silicon-based material is not particularly limited, the silicon-based material may be spherical, oval, faceted, band-shaped, fibrous, flaky, donut-shaped or hollow powder, and the silicon-based material may be formed with single particles or granules.

As the skeleton-forming agent of the present embodiment, a skeleton-forming agent including a silicate having a siloxane bond or a phosphate having an aluminophosphate bond is used. More specifically, the skeleton-forming agent preferably includes a silicate represented by general formula (1) below.

[Chem. 1]

A₂O.nSiO₂ formula (1)

In general formula (1) above, A represents an alkali metal. In particular, at least one type of lithium (Li), sodium (Na) and potassium (K) is preferable as A. As the skeleton-forming agent, the alkali metal salt of a silicate having a siloxane bond as described above is used, and thus a lithium-ion secondary battery which has a high strength, excellent heat resistance and an excellent cycle life is obtained.

In general formula (1) above, n is preferably equal to or greater than 1.6 and equal to or less than 3.9. In a case where n is within the range described above, when the skeleton-forming agent is mixed with water to form a skeleton-forming agent liquid, moderate viscosity is obtained, and when it is applied as the negative electrode active material to the negative electrode including silicon as will be described later, the skeleton-forming agent easily penetrates into the negative electrode. Hence, the lithium-ion secondary battery which has a high strength, excellent heat resistance and an excellent cycle life can be more reliably obtained. More preferably, n is equal to or greater than 2.0 and equal to or less than 3.5.

The silicate described above is preferably amorphous. The amorphous silicate has a disordered molecular arrangement so as not to crack in a specific direction like a crystal. Hence, the amorphous silicate is used as the skeleton-forming agent, and thus the cycle life characteristics of the negative electrode are improved.

For example, the skeleton-forming agent liquid described above is applied as the negative electrode active material to the negative electrode including silicon, and thus the skeleton-forming agent penetrates into the negative electrode active material. Then, it is estimated that silicon forming the negative electrode active material and the silicate forming the skeleton-forming agent are melted together, for example, the hydrolyzed silicate is heated to undergo a hydration reaction (condensation reaction of silanol groups) so as to form a siloxane bond (—Si—O—Si). In other words, in the lithium-ion secondary battery negative electrode of the present embodiment, on the interface between the negative electrode active material and the skeleton-forming agent, the interface layer formed of inorganic substances is formed, and the interface layer includes the silicon derived from the siloxane bond and the alkali metal generated, for example, by the hydrolysis of the silicate. Then, it is estimated that, by the existence of the interface layer, the negative electrode active material and the skeleton-forming agent are firmly bonded together, and that consequently, excellent cycle life characteristics are obtained.

In the present embodiment, the ratio of the alkali metal atoms to all the constituent atoms of the interface layer is preferably higher than the ratio of the alkali metal atoms to all the constituent atoms of the skeleton-forming agent. More specifically, the ratio of the alkali metal atoms to all the constituent atoms of the interface layer is preferably five or more times as high as the ratio of the alkali metal atoms to all the constituent atoms of the skeleton-forming agent. In this way, the negative electrode active material and the skeleton-forming agent are more firmly bonded together, and thus peeling caused by the expansion and contraction of the negative electrode active material at the time of charging and discharging and the occurrence of a wrinkle or a crack of the collector are more suppressed, with the result that the cycle life is more improved.

The thickness of the interface layer described above is preferably 3 to 30 nm. When the thickness of the interface layer is within this range, the negative electrode active material and the skeleton-forming agent are more firmly bonded together, and thus peeling caused by the expansion and contraction of the negative electrode active material at the time of charging and discharging and the occurrence of a wrinkle or a crack of the collector are more suppressed, with the result that the cycle life is more improved.

The skeleton-forming agent of the present embodiment preferably includes a phosphate represented by general formula (2) below.

[Chem. 2]

M.nHₓPO₄ formula (2)

In general formula (2) above, M represents at least one type of Al, Ca and Mg. Among them, Al is preferable in terms of excellent mechanical strength, binding properties and wear resistance. X is 0 to 2, and in terms of excellent binding properties, X is preferably 1 to 2 and more preferably 2. n is 0.5 to 5, and in terms of excellent mechanical strength, binding properties and wear resistance, n is preferably 2.5 to 3.5. As with the silicate described above, the phosphate is preferably amorphous and more preferably an amorphous solid which shows a glass transition phenomenon by a temperature rise.

The skeleton-forming agent of the present embodiment may include a surfactant. In this way, the lyophilic property of the skeleton-forming agent into the negative electrode is improved, and thus the skeleton-forming agent uniformly penetrates into the negative electrode. Hence, a, uniform skeleton is formed in the active material layer within the negative electrode, and thus the cycle life characteristics are more improved.

A content (density) of the skeleton-forming agent in the negative electrode is preferably 0.1 to 1.0 mg/cm². The content of the skeleton-forming agent in the negative electrode is within this range, and thus the effects produced by the use of the skeleton-forming agent described above are more reliably achieved.

When the total solid content of the negative electrode active material, the skeleton-forming agent, the binder and the conductivity aid is assumed to be 100% by mass, the content of the skeleton-forming agent is preferably 3.0 to 40.0% by mass. The content of the skeleton-forming agent is within this range, and thus the effects produced by the use of the skeleton-forming agent described above are more reliably achieved. The content of the skeleton-forming agent in the negative electrode layer is set equal to or greater than 3.0% by mass, and thus the function of the skeleton-forming agent is more sufficiently obtained. The content of the skeleton-forming agent is set equal to or less than 40.0% by mass, and thus it is possible to more prevent a decrease in energy density. The content of the skeleton-forming agent is more preferably 5.0 to 30.0% by mass.

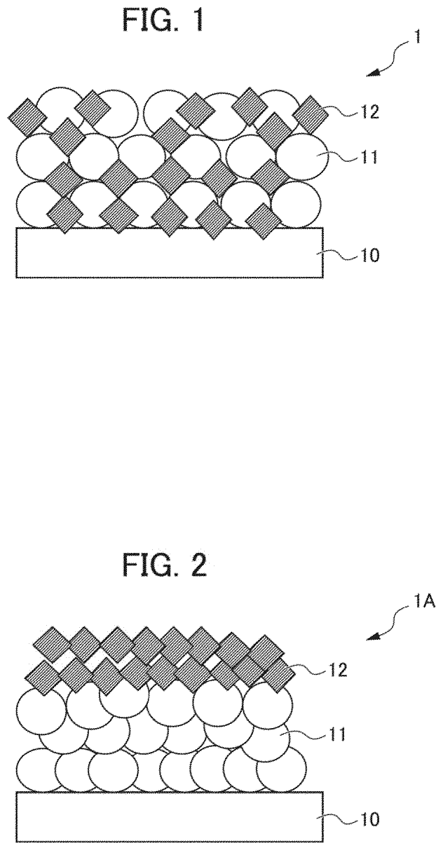

Here, FIG. 1 is a cross-sectional schematic view of the non-aqueous electrolyte secondary battery negative electrode 1 according to the present invention. FIG. 2 is a cross-sectional schematic view of a conventional non-aqueous electrolyte secondary battery negative electrode 1A. As shown in FIG. 1, in the non-aqueous electrolyte secondary battery negative electrode 1 of the present embodiment, the skeleton-forming agent 12 is arranged on at least the interface of the negative electrode layer with the collector 10. More specifically, the skeleton-forming agent 12 is arranged not only on the interface between the collector 10 and the negative electrode layer but also uniformly in the entire negative electrode layer, and thus the skeleton-forming agent 12 exists to be dispersed in the negative electrode active material 11. By contrast, in the conventional non-aqueous electrolyte secondary battery negative electrode 1A, the skeleton-forming agent 12 is unevenly distributed on the surface of the negative electrode layer.

In the present embodiment, as described later, a negative electrode layer precursor formed by applying the negative electrode material including the negative electrode active material, the conductivity aid and the binder on the collector is impregnated with the skeleton-forming agent so as to form the negative electrode layer. Here, as will be described later, the density of the negative electrode layer precursor and the density of the negative electrode layer are controlled by the selection of the type of material and the amount of material so as to spread the skeleton-forming agent used in the impregnation into the negative electrode layer, with the result that the skeleton-forming agent is also arranged on the interface of the negative electrode layer with the collector. On the other hand, in the conventional non-aqueous electrolyte secondary battery negative electrode 1A, the densities are not controlled unlike the present embodiment, and thus the skeleton-forming agent is deposited on the negative electrode layer so as to unevenly exist. Hence, in the present embodiment, the skeleton-forming agent is uniformly arranged within the entire negative electrode layer, and thus the skeleton is formed with the skeleton-forming agent so as to obtain a high mechanical strength, with the result that the cycle life characteristics are improved.

The lithium-ion secondary battery negative electrode according to the present embodiment includes the conductivity aid. The conductivity aid is not particularly limited as long as the conductivity aid has electron conductivity, and a metal, a carbon material, a conductive polymer, conductive glass and the like can be used. Specific examples thereof include acetylene black (AB), ketjen black (KB), furnace black (FB), thermal black, lamp black, channel black, roller black, disc black, carbon black (CB), carbon fiber (for example, vapor growth carbon fiber VGCF (registered trademark)), carbon nanotube (CNT), carbon nanohorn, graphite, graphene, glassy carbon, amorphous carbon and the like, and one or two or more types thereof can be used:

When the total of the negative electrode active material, the binder and the conductivity aid contained in the negative electrode is assumed to be 100% by mass, a content of the conductivity aid is preferably 0 to 20.0% by mass. The content of the conductivity aid is within this range, and thus conductivity can be improved without a negative electrode capacity density being lowered, and air gaps can be formed to keep the sufficient skeleton-forming agent within the negative electrode layer. The content of the conductivity aid is more preferably 8.8 to 25.0% by mass.

The bulk density of the conductivity aid of the present embodiment is preferably 0.04 to 0.25 mg/cm³. The bulk density of the conductivity aid is within this range, and thus the impregnation can be sufficiently performed with the skeleton-forming agent described above, with the result that the above-described effects produced by the skeleton-forming agent can be sufficiently achieved. The bulk density of the conductivity aid is more preferably 0.04 to 0.15 mg/cm³.

The lithium-ion secondary battery negative electrode according to the present embodiment includes the binder. As the binder, for example, one type of organic materials such as polyvinylidene fluoride (PVdF), polytetrafluoroethylene (PTFE), polyimide (PI), polyamide, polyamideimide, aramid, polyacrylic, styrene butadiene rubber (SBR), ethylene-vinyl acetate copolymer (EVA), styrene-ethylene-butylene-styrene copolymer (SEBS), carboxymethyl cellulose (CMC), xanthan gum, polyvinyl alcohol (PVA), ethylene vinyl alcohol, polyvinyl butyral (PVB), polyethylene (PE), polypropylene (PP), polyacrylic acid, lithium polyacrylate, sodium polyacrylate, potassium polyacrylate, ammonium polyacrylate, methyl polyacrylate, ethyl polyacrylate, amine polyacrylate, polyacrylic acid ester, epoxy resin, polyethylene terephthalate (PET), polybutylene terephthalate (PBT), nylon, vinyl chloride, silicone rubber, nitrile rubber, cyanoacrylate, urea resin, melamine resin, phenol resin, latex, polyurethane, silylated urethane, nitrocellulose, dextrin, polyvinylpyrrolidone, vinyl acetate, polystyrene, chloropropylene, resorcinol resin, polyaromatic, modified silicone, methacrylic resin, polybutene, butyl rubber, 2-propenic acid, cyanoacrylic acid, methyl methacrylate, glycidyl methacrylate, acrylic oligomer, 2-hydroxyethyl acrylate, alginic acid, starch, lacquer, sucrose, glue, casein and cellulose nanofiber may be used singly or two or more types thereof may be used together.

Binders obtained by mixing various types of organic binders described above and inorganic binders may be used. As the inorganic binder, silicate-based, phosphate-based, sol-based, cement-based binders and the like are mentioned. For example, one type of inorganic materials such as lithium silicate, sodium silicate, potassium silicate, cesium silicate, guanidine silicate, ammonium silicate, fluosilicic salt, borate, lithium aluminate, sodium aluminate, potassium aluminate, aluminosilicate, lithium aluminate, sodium aluminate, potassium aluminate, polyaluminum chloride, aluminum polysulfate, aluminum silicate polysulfate, aluminum sulfate, aluminum nitrate, ammonium alum, lithium alum, sodium alum, potassium alum, chrome alum, iron alum, manganese alum, nickel ammonium sulfate, diatomaceous soil, polyzirconoxane, polytantaroxane, mullite, white carbon, silica sol, colloidal silica, fumed silica, alumina sol, colloidal alumina, fumed alumina, zirconia sol, colloidal zirconia, fumed zirconia, magnesia sol, colloidal magnesia, fumed magnesia, calcia sol, colloidal calcia, fumed calcia, titania sol, colloidal titania, fumed titania, zeolite, silicoaluminophosphate zeolite, sepiolite, montmorillonite, kaolin, saponite, aluminum phosphate salt, magnesium phosphate salt, calcium phosphate salt, iron phosphate salt, copper phosphate salt, zinc phosphate salt, titanium phosphate salt, manganese phosphate salt, barium phosphate salt, tin phosphate salt, low melting point glass, mortar, plaster, magnesium cement, litharge cement, portoland cement, blast furnace cement, fly ash cement, silica cement, phosphate cement, concrete and solid electrolyte may be used singly or two or more types thereof may be used together.

In the present embodiment, with the interface layer described above and formed by the use of the skeleton-forming agent, the negative electrode active material and the skeleton-forming agent are firmly bonded together, and thus all the binders described above can be used. When the total of the negative electrode active material, the binder and the conductivity aid contained in the negative electrode is assumed to be 100% by mass, a content of the binder is preferably 0.1 to 60% by mass. The content of the binder is within this range, and thus ion conductivity can be improved without the negative electrode capacity density being lowered, and a high mechanical strength and excellent cycle life characteristics are obtained. The content of the binder is more preferably 0.5 to 30% by mass.

The collector used in the lithium-ion secondary battery negative electrode according to the present embodiment is not particularly limited as long as the collector has electron conductivity and is a material capable of energizing the negative electrode active material which is held. For example, conductive substances such as C, Ti, Cr, Ni, Cu, Mo, Ru, Rh, Ta, W, Os, Ir, Pt, Al and Au and alloys (for example, stainless steel) containing two or more types of these conductive substances can be used. When a substance other than the conductive substances described above is used, for example, a multilayer structure of different metals such as a multilayer structure obtained by coating iron with Cu or Ni may be used.

In terms of high electrical conductivity and high stability in an electrolytic solution, C, Ti, Cr, Au, Fe, Cu, Ni, stainless steel and the like are preferable as the collector, and furthermore, in terms of reduction resistance and the material cost, C, Cu, Ni, stainless steel and the like are preferable. When iron is used as a collector base material, in order to prevent the oxidation of the surface of the collector base material, a collector coated with Ni or Cu is preferable. In a conventional alloy-based negative electrode, the volume of a negative electrode material is significantly changed by charging and discharging, and thus it is considered that stainless steel or iron is preferable as the collector base material. However, in the present embodiment, stress applied to the collector can be suppressed with the skeleton-forming agent, and thus all the materials described above can be used.

Examples of the shape of the collector used in the negative electrode include a linear shape, a rod shape, a plate shape, a foil shape and a porous shape, and, among them, since a filling density can be increased and the skeleton-forming agent easily penetrates into the active material layer, the collector may have a porous shape. Examples of the porous shape include a mesh, a woven fabric, a non-woven fabric, an embossed material, a punched material, an expanded material, a foamed material and the like.

### [Positive Electrode]

A positive electrode when the lithium-ion secondary battery is formed with the negative electrode described above will then be described. A positive electrode active material is not particularly limited as long as the positive electrode active material is normally used in a lithium-ion secondary battery. For example, positive electrode active materials such as alkali metal transition metal oxide-based, vanadium-based, sulfur-based, solid solution-based (lithium excess-based, sodium excess-based and potassium excess-based), carbon-based and organic substance-based positive electrode active materials are used.

As with the negative electrode described above, the lithium-ion secondary battery positive electrode of the present embodiment may include a skeleton-forming agent. As the skeleton-forming agent, the same skeleton-forming agent as used in the negative electrode described above can be used, and the preferred content of the skeleton-forming agent is the same as in the negative electrode.

The lithium-ion secondary battery positive electrode of the present embodiment may include a conductivity aid. As the conductivity aid, the various types of conductivity aids which are described above and which can be used in the negative electrode are used. The preferred content of the conductivity aid is the same as in the negative electrode.

The lithium-ion secondary battery positive electrode of the present embodiment may include a binder. As the binder, for example, one type of organic materials such as polyvinylidene fluoride (PVdF), polytetrafluoroethylene (PTFE), polyacrylic and alginic acid may be used singly or two or more types thereof may be used together. Binders obtained by mixing these organic binders and inorganic binders may be used. As the inorganic binder, for example, silicate-based, phosphate-based, sol-based, cement-based binders and the like are mentioned.

A collector used in the positive electrode is not particularly limited as long as the collector has electron conductivity and is a material capable of energizing the positive electrode active material which is held. For example, conductive substances such as C, Ti, Cr, Ni, Cu, Mo, Ru, Rh, Ta, W, Os, Ir, Pt, Au and Al and alloys (for example, stainless steel) containing two or more types of these conductive substances can be used. When a substance other than the conductive substances described above is used, for example, a multilayer structure of different metals such as a multilayer structure obtained by coating iron with Al may be used. In terms of high electrical conductivity and high stability in an electrolytic solution, C, Ti, Cr, Au, Al, stainless steel and the like are preferable as the collector, and furthermore, in terms of oxidation resistance and the material cost, C, Al, stainless steel and the like are preferable. Al coated with carbon and stainless steel coated with carbon are more preferable.

Examples of the shape of the collector used in the positive electrode include a linear shape, a rod shape, a plate shape, a foil shape and a porous shape, and, among them, since a filling density can be increased and the skeleton-forming agent easily penetrates into the active material layer, the collector may have a porous shape. Examples of the porous shape include a mesh, a woven fabric, a non-woven fabric, an embossed material, a punched material, an expanded material, a foamed material and the like.

### [Separator]

In the lithium-ion secondary battery of the present embodiment, as a separator, a separator which is normally used in a lithium-ion secondary battery can be used. For example, as the separator, a glass non-woven fabric, an aramid non-woven fabric, a polyimide microporous membrane, a polyolefin microporous membrane and the like can be used.

### [Electrolyte]

In the lithium-ion secondary battery of the present embodiment, as the electrolyte, an electrolyte which is normally used in a lithium-ion secondary battery can be used. For example, an electrolytic solution in which an electrolyte is dissolved in a solvent, a gel electrolyte, a solid electrolyte, an ionic liquid, a molten salt and the like are mentioned. Here, the electrolytic solution refers to a liquid in a state where an electrolyte is dissolved in a solvent.

As an electrolyte in a lithium-ion secondary battery, the electrolyte needs to contain lithium ions as a carrier responsible for electrical conductivity, and thus as the electrolyte salt thereof, a lithium salt is preferable though the electrolyte salt is not particularly limited as long as it is used in a lithium-ion secondary battery. As the lithium salt, at least one or more types selected from the group consisting of lithium hexafluorophosphate (LiPF₆), lithium perchlorate (LiClO₄), lithium tetrafluoroborate (LiBF₄), lithium trifluoromethanesulfonate (LiCF₃SO₄), lithium bistrifluoromethanesulfonylimide (LiN(SO₂CF₃)₂), lithium bispentafluoroethanesulfonylimide (LiN(SO₂C₂F₅)₂), lithium bisoxalate borate (LiBC₄O₈) and the like can be used or two or more types can be used together.

Although the solvent of the electrolyte is not particularly limited as long as the solvent is used in a lithium-ion secondary battery, at least one type selected from the group consisting of propylene carbonate (PC), ethylene carbonate (EC), dimethyl carbonate (DMC), diethyl carbonate (DEC), ethyl methyl carbonate (EMC), γ-butyrolactone (GBL), methyl-γ-butyrolactone, dimethoxymethane (DMM), dimethoxyethane (DME), vinylene carbonate (VC), vinylethylene carbonate (EVC), fluoroethylene carbonate (FEC) ethylenesulfite (ES) and the like can be used or two or more types can be used together.

Although the concentration of the electrolytic solution (concentration of a salt in the solvent) is not particularly limited, the concentration is preferably 0.1 to 3.0 mol/L and further preferably 0.8 to 2.0 mol/L.

The types of cations (positive ions) in an ionic liquid and a molten salt are categorized as pyridine-based, alicyclic amine-based, aliphatic amine-based cations and the like. The types of anions (negative ions) which are combined with those described above are selected, and thus various ionic liquids and molten salts can be synthesized. Examples of the cation include ammonium-based ions such as imidazolium salts and pyridinium salts, phosphonium-based ions, inorganic-based ions and the like, and examples of the anion adopted include halogen-based ions such as a bromide ion and triflate, boron-based ions such as tetraphenylborate, phosphorus-based ions such as hexafluorophosphate and the like.

The ionic liquid and the molten salt can be obtained by a known synthesis method of combining, for example, a cation such as imidazolinium and an anion such as Br⁻, Cl⁻, BF⁴⁻, PF⁶⁻, (CF₃SO₂)₂N⁻, CF₃SO³⁻ or FeCl⁴⁻. When the ionic liquid or the molten salt is used, it can function as an electrolytic solution without addition of an electrolyte.

Solid electrolytes are categorized as sulfide-based, oxide-based, hydride-based, organic polymer-based electrolytes and the like. Most of these are amorphous or crystalline materials formed of a salt serving as a carrier and an inorganic derivative. Unlike an electrolytic solution, it is not necessary to use a flammable aprotic organic solvent, and thus the ignition of a gas or liquid, the leakage of a liquid and the like are unlikely to occur, with the result that it is expected that a significantly safe secondary battery is provided.

### [Manufacturing Method]

A method for manufacturing a lithium-ion secondary battery according to the present embodiment will then be described. The manufacturing method is the same for the negative electrode and the positive electrode except that the collector and the active material which are used are different. Hence, only the method for manufacturing the negative electrode will be described, and the description of the method for manufacturing the positive electrode will be omitted.

The method for manufacturing the lithium-ion secondary battery negative electrode according to the present embodiment includes a first step of applying, on the collector, the negative electrode material including the negative electrode active material, the conductivity aid and the binder and drying the negative electrode material so as to form the negative electrode layer precursor. For example, while a 10 μm thin rolled copper foil is manufactured and the copper foil which is previously wound in a roll shape is prepared, as the negative electrode material, the negative electrode active material, the binder, the conductivity aid and the like are mixed together to prepare slurry in paste form. Then, the negative electrode material in slurry form is applied to the surface of the copper foil and is dried, and thereafter pressure adjustment treatment is performed to obtain the negative electrode layer precursor.

As described above, the negative electrode layer precursor may be in a wet state without being dried. In addition to the slurry application described above, for example, a method for using a chemical plating method, a sputtering method, a vapor deposition method, a gas deposition method or the like so as to integrally form the negative electrode active material layer of the negative electrode active material (precursor) on the collector is mentioned. However, in terms of the lyophilic property of the skeleton-forming agent and an electrode manufacturing cost, the slurry application method is preferable.

The method for manufacturing the lithium-ion secondary battery negative electrode according to the present embodiment also includes a second step of impregnating the negative electrode layer precursor formed in the first step with the skeleton-forming agent including a silicate having a siloxane bond or a phosphate having a phosphate bond and drying the negative electrode layer precursor so to form the negative electrode layer. For example, the silicate having the siloxane bond or the phosphate having the phosphate bond is purified by a dry or wet method and is subjected to water adjustment so as to prepare the skeleton-forming agent liquid including the skeleton-forming agent. Here, a surfactant may be mixed. As the dry method, for example, SiO₂ is added into water in which an alkali metal hydroxide is dissolved and is treated in an autoclave at 150 to 250° C., and thus it is possible to manufacture an alkali metal silicate. As the wet method, for example, a mixture of an alkali metal carbonate compound and SiO₂ is burned at 1000 to 2000° C. and is dissolved in hot water, and thus it is possible to manufacture an alkali metal silicate.

Then, the skeleton-forming agent liquid is applied to the surface of the negative electrode layer precursor so as to coat the negative electrode active material. As a method for applying the skeleton-forming agent, in addition to a method for impregnating the precursor of the negative electrode in a chamber in which the skeleton-forming agent liquid is stored, a method for dropping or applying the skeleton-forming agent on the surface of the precursor of the negative electrode, spray application, screen printing, a curtain method, spin coating, gravure coating, die coating and the like can be performed. The skeleton-forming agent applied to the surface of the negative electrode layer precursor penetrates into the negative electrode so as to enter the gaps and the like of the negative electrode active material and the conductivity aid. Then, the skeleton-forming agent is dried by heat treatment so as to be cured. In this way, the skeleton-forming agent forms the skeleton of the negative electrode active material layer.

Since in the heat treatment described above, as its temperature is increased, the time of the heat treatment can be reduced and the strength of the skeleton-forming agent is improved, the temperature is preferably equal to or greater than 80° C., more preferably equal to or greater than 100° C. and desirably equal to or greater than 110° C. The upper limit temperature of the heat treatment is not particularly limited as long as the collector is not melted, and, for example, the temperature may be increased to about 1000° C., which is the melting point of copper. Although in a conventional electrode, the binder may be charred or the collector may be softened, and thus the upper limit temperature is estimated to be excessively lower than 1000° C., in the present embodiment, the skeleton-forming agent is used, and thus the skeleton-forming agent has excellent heat resistance and has a higher strength than the collector, with the result that the upper limit of the temperature is 1000° C.

With respect to the time of the heat treatment, the heat treatment can be performed by being held for 0.5 to 100 hours. Although the heat treatment may be performed in the atmosphere, the heat treatment is preferably performed under a non-oxidizing atmosphere so as to prevent the oxidation of the collector.

Here, in the method for manufacturing the lithium-ion secondary battery negative electrode according to the present embodiment, control is performed such that B/A which is a ratio of the density B of the negative electrode formed in the second step to the density A of the negative electrode layer precursor formed in the first step is in a range of 0.9<B/A<1.4. Specifically, by selecting the type of material, the amount of material, treatment conditions and the like, the control is performed such that B/A (that is, a density increase ratio) which is the ratio of the density B of the negative electrode to the density A of the negative electrode layer precursor is within the range described above. In this way, the skeleton-forming agent used in the impregnation is spread into the negative electrode layer, with the result that the skeleton-forming agent is also arranged on the interface of the negative electrode layer with the collector. Hence, by the formation of the skeleton with the skeleton-forming agent arranged uniformly within the entire negative electrode layer, a high mechanical strength is obtained, and thus the cycle life characteristics are improved.

In the method for manufacturing the lithium-ion secondary battery negative electrode according to the present embodiment, the density A of the negative electrode layer precursor formed in the first step is set to 0.5 to 1.3 g/cm³. In this way, B/A (that is, the density increase ratio) which is the ratio of the density B of the negative electrode to the density A of the negative electrode layer precursor can be more reliably set within the range described above, with the result that the effects of the skeleton-forming agent described above can be improved. The density A of the negative electrode layer precursor is more preferably in a range of 0.6 to 1.0 g/cm³. The density A of the negative electrode layer precursor is set equal to or greater than 0.6 g/cm³ so as to be able to suppress a decrease in energy density caused by a decrease in electrode density, and is set equal to or less than 1.0 g/cm³ so as to be able to suppress a decrease in capacity.

Finally, the negative electrode and the positive electrode obtained are respectively cut to desired sizes, are joined through the separator and are sealed in a state where they are immersed in the electrolytic solution, and thus it is possible to obtain the lithium-ion secondary battery. The structure of the lithium-ion secondary battery can be applied to the form or structure of an existing battery such as a multilayer battery or a winding battery.

### [Effects]

According to the present embodiment, the following effects are achieved. In the present embodiment, the negative electrode layer includes the negative electrode active material, the conductivity aid, the binder and the skeleton-forming agent including a silicate having a siloxane bond and a phosphate having a phosphate bond, and the skeleton-forming agent is arranged on at least the interface of the negative electrode layer with the collector. In the present embodiment, the skeleton-forming agent is arranged on at least the interface of the negative electrode layer with the collector, and thus the skeleton-forming agent can be sufficiently spread into the negative electrode layer as compared with a conventional one in which the skeleton-forming agent is unevenly distributed on the surface of the negative electrode layer. In other words, it is possible to achieve the structure of the negative electrode which can keep the skeleton-forming agent within the negative electrode layer, and thus it is possible to strengthen the network of the formation of the skeleton with the skeleton-forming agent. Hence, it is possible to suppress peeling caused by the expansion and contraction of the negative electrode active material at the time of charging and discharging and the occurrence of a wrinkle or a crack of the collector. Therefore, it is possible to provide a high strength and excellent heat resistance so as to improve the cycle life characteristics as compared with the conventional one. Furthermore, the skeleton-forming agent is sufficiently spread to the interface with the collector, and thus it is possible to increase a reversible capacity, with the result that a large charge/discharge capacity is obtained.

In the present embodiment, the content of the skeleton-forming agent in the negative electrode layer is 5 to 40% by mass, and thus the above-described effects produced with the skeleton-forming agent are improved. Likewise, the bulk density of the conductivity aid is 0.04 to 0.25 mg/cm³, and thus the above-described effects produced with the skeleton-forming agent are more reliably achieved. As the negative electrode active material, a silicon-based material containing silicon is used, and thus the formation of the skeleton with the skeleton-forming agent is more strengthened.

In the present embodiment, the method for manufacturing the negative electrode includes: the first step of applying, on the collector, the negative electrode material including the negative electrode active material, the conductivity aid and the binder and drying the negative electrode material so as to form the negative electrode layer precursor; and the second step of impregnating the negative electrode layer precursor formed in the first step with the skeleton-forming agent including a silicate having a siloxane bond or a phosphate having a phosphate bond and drying the negative electrode layer precursor so to form the negative electrode layer, B/A which is the ratio of the density B of the negative electrode formed in the second step to the density A of the negative electrode layer precursor formed in the first step is in the range of 0.9<B/A<1.4 and thus the negative electrode is manufactured. In the present embodiment, the density of the negative electrode layer precursor and the density of the negative electrode layer are controlled by the selection of the type of material and the amount of material so as to spread the skeleton-forming agent used in the impregnation into the negative electrode layer, with the result that the skeleton-forming agent is also arranged on the interface of the negative electrode layer with the collector, a high mechanical strength is obtained by the formation of the skeleton with the skeleton-forming agent and thus the cycle life characteristics are reliably improved.

In the present embodiment, the density A of the negative electrode layer precursor formed in the first step is set to 0.5 to 1.3 g/cm³, and thus the above-described effects produced with the skeleton-forming agent are more reliably achieved.

The present invention is not limited to the embodiment described above, and variations and modifications are included in the present invention as long as the object of the present invention can be achieved. For example, the non-aqueous electrolyte secondary battery which is a secondary battery (electricity storage device) using, as its electrolyte, a non-aqueous electrolyte such as an organic solvent includes, in addition to a lithium-ion secondary battery, a sodium-ion secondary battery, a potassium-ion secondary battery, a magnesium-ion secondary battery, a calcium-ion secondary battery and the like. The lithium-ion secondary battery means a non-aqueous electrolyte secondary battery whose main component is not water and a battery which includes lithium ions as a carrier responsible for electrical conductivity. For example, the lithium-ion secondary battery, a metal lithium battery, a lithium-polymer battery, a lithium all-solid-state battery, an air lithium-ion battery and the like are included. The same is true for other secondary batteries. Here, the non-aqueous electrolyte whose main component is not water means that the main component in the electrolyte is not water. In other words, it is a known electrolyte used in the non-aqueous electrolyte secondary battery. This electrolyte can function as a secondary battery even when it includes a small amount of water but this adversely affects the cycle characteristics, the storage characteristics and input/output characteristics of the secondary battery, and thus the electrolyte in which water is minimized is desirable. The amount of water in the electrolyte is realistically preferably equal to or less than 5000 ppm.

### EXAMPLES

Although Examples of the present invention will then be described, the present invention is not limited to these Examples.

### Examples 1 to 14, Comparative Examples 1 to 6

Slurries which included silicon serving as a negative electrode active material, various types of conductivity aids shown in table 1 and polyvinylidene fluoride (PVdF) serving as a binder were individually prepared. Then, the prepared slurries were applied to a copper foil serving as a collector and were dried, and thereafter pressure adjustment treatment was performed to obtain negative electrode layer precursors. The densities A of the negative electrode layer precursors were as shown in table 1.

On the other hand, as a skeleton-forming agent liquid including a skeleton-forming agent and water, an aqueous solution of 10% by mass of Na₂O·3SiO₂ was prepared. The prepared skeleton-forming agent liquid was applied to the surface of an electrode with a spray so as to make the skeleton-forming agent penetrate thereinto. In each of Examples and Comparative Examples, the sprayed amount was adjusted so as to adjust the amount of skeleton-forming agent applied. Then, the precursors of individual negative electrodes were heated and dried at 160° C., and thus the negative electrodes in which negative electrode layers were formed were obtained. The amounts of skeleton-forming agent and the amounts of conductivity aids in the obtained negative electrodes were as shown in table 1, and the amount of binder was 4% by mass. The ratios B/A of the densities B of the negative electrode layers to the densities A of the negative electrode layer precursors were as shown in table 1.

A conductivity aid 1 in table 1 was powdered acetylene black whose bulk density was 0.05 g/ml and whose average particle diameter was 23 μm. A conductivity aid 2 was powdered acetylene black whose bulk density was 0.08 g/ml and whose average particle diameter was 37 μm. A conductivity aid 3 was powdered furnace black whose bulk density was 0.25 g/ml and whose average particle diameter was 6.2 μm. A conductivity aid 4 was liquid acetylene black whose bulk density was 0.15 g/ml, whose average particle diameter was 48 μm and which was dispersed in NMP.

As the opposite electrode of the negative electrode, a lithium metal foil (thickness of 500 μm) was used. As a separator, a glass non-woven fabric was used, and an electrolytic solution (1.1 M LiPF₆/(EC:EMC:DEC=3:4:3 vol.)) in which lithium hexafluorophosphate (LiPF₆) serving as an electrolyte was dissolved in ethylene carbonate (EC)/ethyl methyl carbonate (EMC)/diethyl carbonate (DEC) serving as an organic solvent was used so as to produce a lithium-ion secondary battery.

TABLE 1

| | | Conduc- | | | Skeleton- | Initial |
|---|---|---|---|---|---|---|
| | Conduc- | tivity | Den- | | forming | charge |
| | tivity | aid | sity | | agent | capacity |
| | aid type | amount | A | B/A | amount | (mAh) |
| Example 1 | 1 | 20.1% | 0.54 | 1.36 | 49.2% | 3624 |
| Example 2 | 1 | 14.2% | 0.66 | 1.09 | 36.2% | 3417 |
| Example 3 | 1 | 11.5% | 0.69 | 1.11 | 33.9% | 3010 |
| Example 4 | 1 | 8.8% | 0.73 | 1.04 | 13.9% | 2855 |
| Example 5 | 1 | 5.8% | 0.83 | 1.02 | 6.3% | 2152 |
| Example 6 | 1 | 2.7% | 0.84 | 1.00 | 5.5% | 2046 |
| Example 7 | 1 | 1.0% | 0.86 | 0.95 | 4.2% | 1352 |
| Example 8 | 2 | 20.0% | 0.57 | 1.22 | 31.8% | 3885 |
| Example 9 | 2 | 15.0% | 0.59 | 1.11 | 28.2% | 3661 |
| Example 10 | 2 | 11.0% | 0.68 | 1.19 | 16.9% | 3116 |
| Example 11 | 2 | 8.0% | 0.73 | 1.14 | 7.6% | 2656 |
| Example 12 | 2 | 6.0% | 0.83 | 1.02 | 1.0% | 1230 |
| Example 13 | 3 | 20.0% | 1.11 | 1.08 | 9.8% | 2243 |
| Example 14 | 3 | 15.0% | 0.98 | 1.22 | 14.8% | 2374 |
| Comparative | 4 | 30.0% | 1.01 | 0.91 | 12.8% | 856 |
| Example 1 | | | | | | |
| Comparative | 4 | 25.0% | 1.17 | 0.79 | 4.8% | 885 |
| Example 2 | | | | | | |
| Comparative | 4 | 20.0% | 1.09 | 0.89 | 10.2% | 940 |
| Example 3 | | | | | | |
| Comparative | 4 | 15.0% | 1.17 | 0.79 | 9.3% | 765 |
| Example 4 | | | | | | |
| Comparative | 4 | 10.0% | 1.12 | 0.76 | 9.3% | 741 |
| Example 5 | | | | | | |
| Comparative | 4 | 5.0% | 1.05 | 0.71 | 9.7% | 779 |
| Example 6 | | | | | | |

### [SEM Observation, EDX Measurement]

A cross section enlargement observation was performed with an SEM (scanning electron microscope) on the negative electrodes of Examples and Comparative Examples. While the SEM observation was being performed, element mapping was performed by EDX (Energy Dispersive X-ray Spectroscopy), and thus the distribution of the skeleton-forming agent in cross sections was checked. As a device, an EPMA device “JXA-8500F” made by JEOL Ltd. was used, as electron beam irradiation conditions, an acceleration voltage was 15 kV and an irradiation current was 1 nA and an observation magnification was 2000 times. An observation sample was produced by punching each negative electrode with 5 mmϕ to cut it into a half and thereafter performing non-atmospheric exposure cross-sectional processing on the cut surface thereof by ion milling. For the non-atmospheric exposure cross-sectional processing, a non-atmospheric exposure stage “IM4000PLUS” made by Hitachi High-Tech Corporation. was used. As ion beam conditions, an ion source was Ar gas, an acceleration voltage was 6 kV, a processing mode was C4 (stage swing angle of ±30°, 30 round trips/minute) and a processing time was 2 hours.

### [Cycle Life Test]

A cycle life test was performed on the negative electrodes of Examples and Comparative Examples. The cycle life test was performed under conditions in which a test environment temperature was 25° C., a current density was 0.2 C-rate and a cutoff potential was 0.01 to 1.5 V (vs. Li+/Li).

### [Considerations]

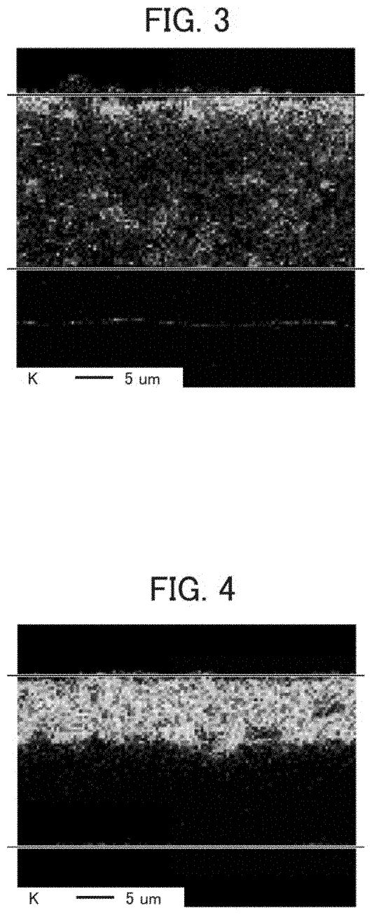

FIG. 3 is an EDX mapping diagram of a cross section of a lithium-ion secondary battery negative electrode in Example 8. FIG. 4 is an EDX mapping diagram of a cross section of a lithium-ion secondary battery negative electrode in Comparative Example 3. As shown in FIG. 3, in the negative electrode of the present Example, potassium derived from the skeleton-forming agent was also detected in the interface of the negative electrode layer with the collector, and thus it was confirmed that the skeleton-forming agent was spread over the entire negative electrode layer to the interface of the negative electrode layer with the collector. On the other hand, as shown in FIG. 4, in a conventional negative electrode as in the present Comparative Example, potassium derived from the skeleton-forming agent was only detected on the surface of the negative electrode layer, and thus it was confirmed that the skeleton-forming agent was unevenly distributed on the surface of the negative electrode layer. Although the EDX mapping diagrams of Example 8 and Comparative Example 3 are shown as typical examples, the same results as in the other Examples and Comparative Examples were confirmed.

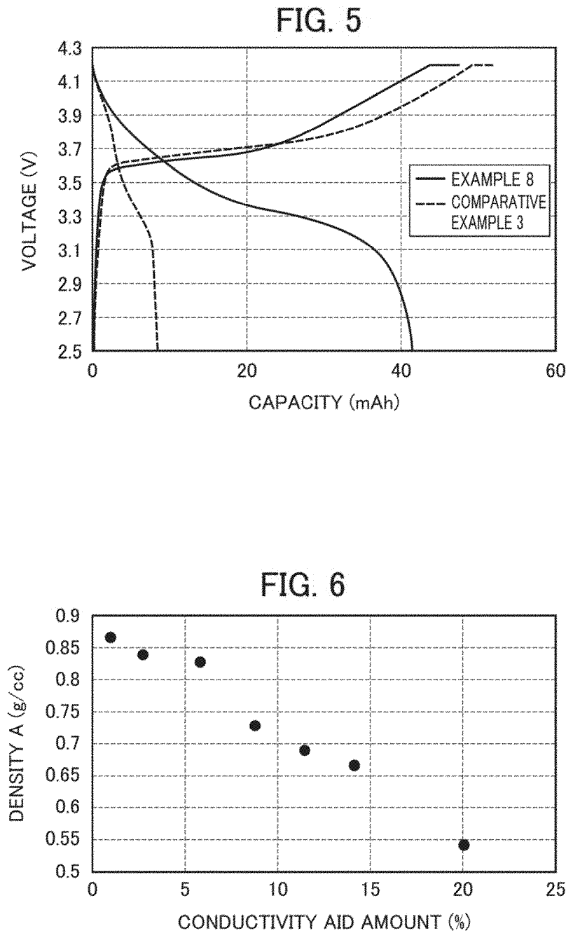

FIG. 5 is a charge/discharge curve diagram when positive electrodes formed of NCM622 (LiNi_{0.6}Co_{0.2}Mn_{0.2}O₂)/PVdF/AB=93:4:3 (mass ratio) were used as the opposite electrodes of Example 8 and Comparative Example 3. As shown in FIG. 5, it was confirmed that, as compared with the negative electrode of Comparative Example 3, the negative electrode of Example 8 had a large charge/discharge capacity. Consequently, it was confirmed that the skeleton-forming agent is made to sufficiently penetrate to the interface with the collector, and that thus it is possible to increase a reversible capacity. Although the charge/discharge curve diagrams of Example 8 and Comparative Example 3 are shown as typical examples, the same results were confirmed in the other Examples and Comparative Examples as is clear from the initial discharge capacities of the Examples and Comparative Examples shown in table 1.

FIG. 6 is a diagram showing a relationship between the amount of conductivity aid and the density A. Specifically, FIG. 6 is a diagram obtained by plotting the amounts of conductivity aid and the densities A in Examples 1 to 7. As shown in FIG. 6, it was confirmed that, as the amount of conductivity aid was increased, the density A of the negative electrode layer precursor was lowered. Consequently, it was considered that in Examples 1 to 7, air gaps were formed in the negative electrode layer precursor by the increase in the amount of conductivity aid, and thus air gaps which can keep a sufficient skeleton-forming agent were formed within the negative electrode layer.

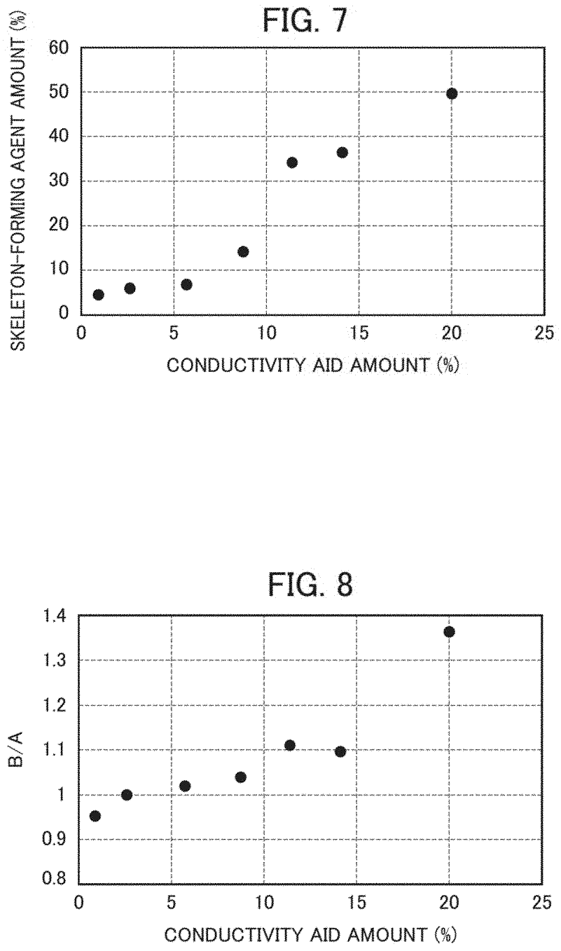

FIG. 7 is a diagram showing a relationship between the amount of conductivity aid and the amount of skeleton-forming agent. Specifically, FIG. 7 is a diagram obtained by plotting the amounts of conductivity aid and the amounts of skeleton-forming agent in Examples 1 to 7. As shown in FIG. 7, it was confirmed that, as the amount of conductivity aid was increased, the amount of skeleton-forming agent was increased. Consequently, it was confirmed that in Examples 1 to 7, the property of keeping the skeleton-forming agent was improved by the increase in the amount of conductivity aid so as to take a large amount of skeleton-forming agent into the negative electrode layer. In particular, it was confirmed that the amount of conductivity aid in the negative electrode layer is within a range of 8.8 to 25.0% by mass, and that thus it is possible to improve the conductivity without lowering a negative electrode capacity density and to take a large amount of skeleton-forming agent into the negative electrode layer.

FIG. 8 is a diagram showing a relationship between the amount of conductivity aid and density B/density A. Specifically, FIG. 8 is a diagram obtained by plotting the amounts of conductivity aid and the ratios of the density B/density A in Examples 1 to 7. As shown in FIG. 8, it was confirmed that, as the amount of conductivity aid was increased, the density B of the negative electrode layer after the penetration of the skeleton-forming agent with respect to the density A was increased. Consequently, it was found that in Examples 1 to 7, the skeleton-forming agent was taken into the air gaps within the negative electrode layer by the increase in the amount of conductivity aid. In particular, it was confirmed that the amount of conductivity aid in the negative electrode layer is within a range of 8.8 to 25.0% by mass, and that thus it is possible to improve the conductivity without lowering the negative electrode capacity density and to take a large amount of skeleton-forming agent into the negative electrode layer.

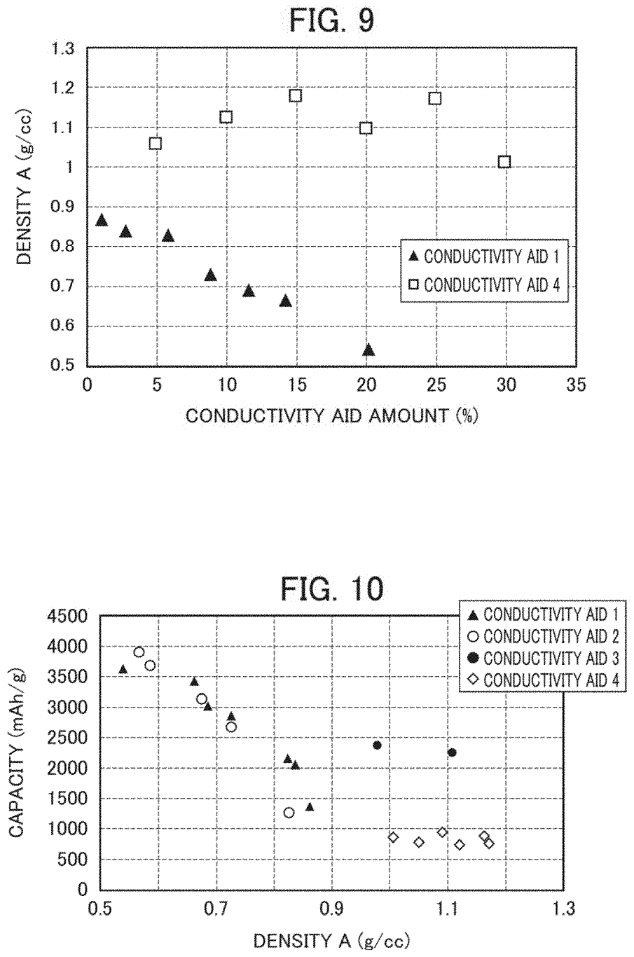

FIG. 9 is a diagram showing a relationship between the amount of conductivity aid and the density A in various types of conductivity aids. Specifically, FIG. 9 is a diagram obtained by plotting the amounts of conductivity aid and the densities A in Examples 1 to 7 and Comparative Examples 1 to 6. As shown in FIG. 9, it was confirmed that, in Examples 1 to 7 using the conductivity aid 1, as described above, as the amount of conductivity aid was increased, the density A of the negative electrode precursor was lowered whereas in Comparative Examples 1 to 6 using the conductivity aid 4, even when the amount of conductivity aid was increased, the density A of the negative electrode precursor was not lowered. In other words, it was confirmed that depending on the type of conductivity aid, even when the amount of conductivity aid was increased, the density A of the negative electrode layer precursor was not lowered and the skeleton-forming agent was not sufficiently taken thereinto, and that consequently, the cycle life was not improved. Consequently, it was confirmed that the conductivity aid 1 whose bulk density was within a range of 0.04 to 0.25 mg/cm³ was used, and that thus as the amount of conductivity aid was increased, the density A of the negative electrode precursor was lowered.

FIG. 10 is a diagram showing a relationship between the density A and the charge/discharge capacity. Specifically, FIG. 10 is a diagram obtained by plotting the densities A and the charge/discharge capacities in Examples 1 to 14 and Comparative Examples 1 to 6. As shown in FIG. 10, it was confirmed that, in Examples 1 to 7 using the conductivity aid 1, Examples 8 to 12 using the conductivity aid 2 and Examples 13 and 14 using the conductivity aid 3, the density A of the negative electrode layer precursor obtained in the first step described above was within a range of 0.5 to 1.3 g/cm³, and that thus a large charge/discharge capacity was obtained. It was found from FIG. 10 that a more preferred range of the density A of the negative electrode layer precursor is 0.6 to 1.0 g/cm³. In other words, it was found that the density A of the negative electrode layer precursor is set equal to or greater than 0.6 g/cm³ so as to be able to more suppress a decrease in energy density caused by a decrease in electrode density, and that the density A of the negative electrode layer precursor is set equal to or less than 1.0 g/cm³ so as to be able to more suppress a decrease in capacity. By contrast, it was confirmed that in Comparative Examples 1 to 6 using the conductivity aid 4, even when the density A of the negative electrode layer precursor was in a range of 0.5 to 1.3 g/cm³, a large charge/discharge capacity was not obtained. Consequently, it was confirmed that the conductivity aids 1 to 3 whose bulk density is within a range of 0.04 to 0.25 mg/cm³ are used and that thus when the density A of the negative electrode layer precursor is in a range of 0.5 to 1.3 g/cm³, a large charge/discharge capacity is obtained. Consequently, it was found that in the powdered conductivity aids 1 to 3, as compared with the liquid conductivity aid 4, the negative electrode density is easily lowered and the skeleton-forming agent easily penetrates thereinto.

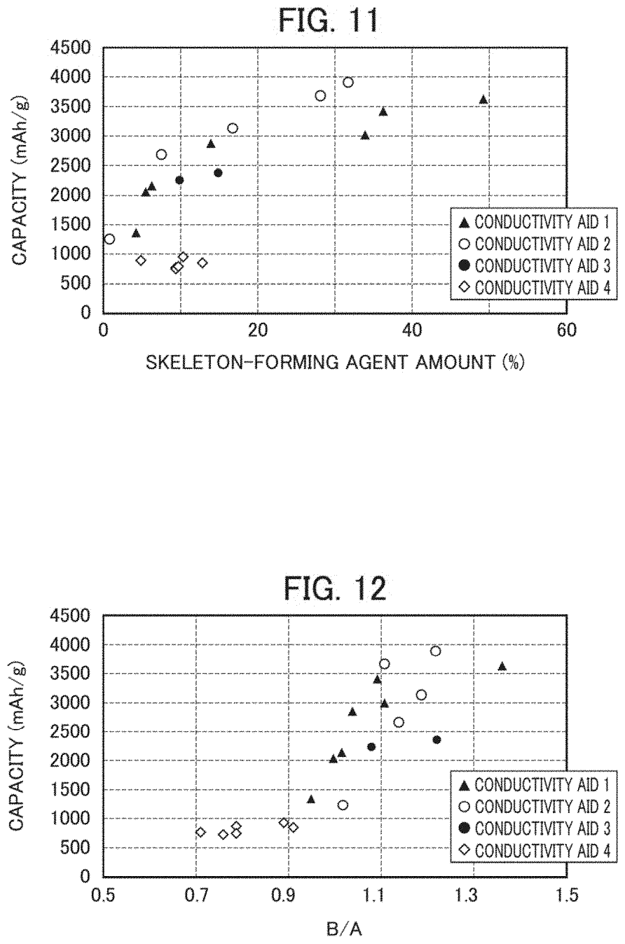

FIG. 11 is a diagram showing a relationship between the amount of skeleton-forming agent and the charge/discharge capacity. Specifically, FIG. 11 is a diagram obtained by plotting the amounts of skeleton-forming agent and the charge/discharge capacities in Examples 1 to 14 and Comparative Examples 1 to 6. As shown in FIG. 11, it was confirmed that, in Examples 1 to 7 using the conductivity aid 1, Examples 8 to 12 using the conductivity aid 2 and Examples 13 and 14 using the conductivity aid 3, a content of the skeleton-forming agent in the negative electrode layer was within a range of 3.0 to 40.0% by mass, and that thus a large charge/discharge capacity was obtained. It was found from FIG. 11 that a more preferred content of the skeleton-forming agent in the negative electrode layer is 5.0 to 30.0% by mass. In other words, it was found that the content of the skeleton-forming agent in the negative electrode layer is set equal to or greater than 5.0% by mass so as to be able to more achieve the function of the skeleton-forming agent, and that the content of the skeleton-forming agent in the negative electrode layer is set equal to or less than 30.0% by mass so as to be able to more suppress a decrease in energy density caused by the weight of the skeleton-forming agent. By contrast, it was confirmed that in Comparative Examples 1 to 6 using the conductivity aid 4, even when the content of the skeleton-forming agent was within a range of 3.0 to 40.0% by mass, a large charge/discharge capacity was not obtained. Consequently, it was confirmed that the conductivity aids 1 to 3 whose bulk density is within a range of 0.04 to 0.25 mg/cm³ are used, that thus when the content of the skeleton-forming agent in the negative electrode layer is within a range of 3.0 to 40.0% by mass, a large charge/discharge capacity is obtained and that therefore a decrease in energy density caused by an increase in the weight of the binder is suppressed. Consequently, it was confirmed that in the powdered conductivity aids 1 to 3, as compared with the liquid conductivity aid 4, the negative electrode density is easily lowered and the skeleton-forming agent easily penetrates thereinto. It was found that in Example 1, though a capacity based on the active material was high, the total mass ratio between the skeleton-forming agent and the conductivity aid was close to 70%, that thus a ratio of the active material in the electrode was about 30% and the actual capacity was about 1000 mAh/total electrode mass g and that therefore the energy density (capacity based on the mass of the electrode) was lowered.

FIG. 12 is a diagram showing a relationship between the density B/density A and the charge/discharge capacity. Specifically, FIG. 12 is a diagram obtained by plotting the ratios of the density B/density A and the charge/discharge capacities in Examples 1 to 14 and Comparative Examples 1 to 6. As shown in FIG. 12, it was confirmed that, in Examples 1 to 7 using the conductivity aid 1, Examples 8 to 12 using the conductivity aid 2 and Examples 13 and 14 using the conductivity aid 3, the density B/density A meaning a density increase rate was in a range of 0.9<B/A<1.4, and that thus a large charge/discharge capacity was obtained. It was found from FIG. 12 that a more preferred range of the density B/density A is 1.0<B/A<1.3. In other words, it was found that by making the density B/density A greater than 1.0, the skeleton-forming agent can sufficiently penetrate into the negative electrode layer, and that by making the density B/density A less than 1.3, a decrease in energy density can be suppressed. By contrast, it was confirmed that in Comparative Examples 1 to 6 using the conductivity aid 4, even when the density B/density A was in a range of 0.9<B/A<1.4, a large charge/discharge capacity was not obtained. Consequently, it was confirmed that the conductivity aids 1 to 3 whose bulk density is within a range of 0.04 to 0.25 mg/cm³ are used, and that thus when the density B/density A is in a range of 0.9<B/A<1.4, a large charge/discharge capacity is obtained. Consequently, it was confirmed that in the powdered conductivity aids 1 to 3, as compared with the liquid conductivity aid 4, the negative electrode density is easily lowered and the skeleton-forming agent easily penetrates thereinto.

### EXPLANATION OF REFERENCE NUMERALS

1 Non-aqueous electrolyte secondary battery negative electrode
10 Collector
11 Negative electrode active material
12 Skeleton-forming agent

What is claimed is:

1. A non-aqueous electrolyte secondary battery negative electrode comprising: a collector; and a negative electrode layer formed on the collector,
wherein the negative electrode layer comprises a negative electrode active material, a conductivity aid, a binder and a skeleton-forming agent comprising a silicate having a siloxane bond or a phosphate having a phosphate bond, and
the skeleton-forming agent is arranged on at least an interface of the negative electrode layer with the collector.

2. The non-aqueous electrolyte secondary battery negative electrode according to claim 1, wherein a content of the skeleton-forming agent in the negative electrode layer is 3.0 to 40.0% by mass.

3. The non-aqueous electrolyte secondary battery negative electrode according to claim 1, wherein a bulk density of the conductivity aid is 0.04 to 0.25 mg/cm³.

4. The non-aqueous electrolyte secondary battery negative electrode according to claim 1, wherein a content of the conductivity aid in the negative electrode layer is 8.8 to 25.0% by mass.

5. The non-aqueous electrolyte secondary battery negative electrode according to claim 1, wherein the negative electrode active material comprises a silicon-based material containing silicon.

6. A non-aqueous electrolyte secondary battery comprising the non-aqueous electrolyte secondary battery negative electrode according to claim 1.

7. A method for manufacturing a non-aqueous electrolyte secondary battery negative electrode comprising a collector and a negative electrode layer formed on the collector, the method comprising:
a first step of applying, on the collector, a negative electrode material comprising a negative electrode active material, a conductivity aid and a binder and drying the negative electrode material so as to form a negative electrode layer precursor; and
a second step of impregnating the negative electrode layer precursor formed in the first step with a skeleton-forming agent comprising a silicate having a siloxane bond or a phosphate having a phosphate bond and drying the negative electrode layer precursor so as to form the negative electrode layer,
wherein B/A which is a ratio of a density B of the negative electrode layer formed in the second step to a density A of the negative electrode layer precursor formed in the first step is in a range of 0.9<B/A<1.4.

8. The method for manufacturing a non-aqueous electrolyte secondary battery negative electrode according to claim 7, wherein the density A of the negative electrode layer precursor formed in the first step is 0.5 to 1.3 g/cm³.
